(19) United States
(12) Patent Application Publication
(10) Pub. No.: US 2008/0249264 A1
(43) Pub. Date: Oct. 9, 2008

(54) Method For Producing Highly Reactive Isobutylene Homo-Or Copolymers from Technical Flows of C4-Hydrocarbon Using Bronsted Acid Catalyst Complexes

(75) Inventors: Phillip Hanefeld, Heidelberg (DE); Volker Bohm, Frankenthal (DE); Marcus Sigl, Mannheim (DE); Nina Challand, Mannheim (DE); Michael Roeper, Wachenheim (DE); Hans-Michael Walter, Freinsheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/092,980

(22) PCT Filed: Nov. 15, 2006
(86) PCT No.: PCT/EP2006/068468

§ 371 Date: May 8, 2008

(30) Foreign Application Priority Data
Nov. 21, 2005 (DE) 102005055819.4

(51) Int. Cl. C08F 10/10; C08F 4/06; C08F 4/52

(52) U.S. Cl. 526/126; 526/348.7; 526/206; 526/194; 526/196; 526/90

(57) ABSTRACT

Preparation of highly reactive isobutene homo- or copolymers with Mₙ=from 500 to 1 000 000 by polymerizing isobutene from technical C₄ hydrocarbon streams having an isobutene content of from 1 to 90% by weight in the liquid phase in the presence of a dissolved, dispersed or supported catalyst complex, by using, as the catalyst complex, a protic acid compound I

[H⁺]ₖY^{k-}.Lₓ (I)
Y^{k-} weakly coordinating k-valent anion which comprises at least one hydrocarbon moiety,
L neutral solvent molecules and
x≧0.

The present invention relates to a process for preparing highly reactive isobutene homo- or copolymers having a number-average molecular weight Mₙ of from 500 to 1 000 000 by polymerizing isobutene from a technical C₄ hydrocarbon stream having an isobutene content of from 1 to 90% by weight in the liquid phase in the presence of a dissolved, dispersed or supported catalyst complex.

Highly reactive polyisobutene homo- or copolymers are understood to mean, in contrast to so-called low-reactivity polymers, those polyisobutenes which comprise a high content of terminal ethylenic double bonds. In the context of the present invention, highly reactive polyisobutenes shall be understood to mean those polyisobutenes which have a content of vinylidene double bonds (α-double bonds) of at least 60 mol %, preferably of at least 70 mol % and in particular of at least 80 mol %, based on the polyisobutene macromolecules. In the context of the present application, vinylidene groups are understood to mean those double bonds whose position in the polyisobutene macromolecule is described by the general formula

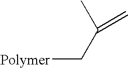

i.e. the double bond is in the α-position in the polymer chain. “Polymer” represents a polyisobutene radical shortened by one isobutene unit. The vinylidene groups exhibit the highest reactivity, whereas a double bond lying further toward the interior of the macromolecules exhibits no or in any case lower reactivity in functionalization reactions. Highly reactive polyisobutenes are used, inter alia, as intermediates for producing additives for lubricants and fuels, as described, for example, in DE-A 27 02 604.

Such highly reactive polyisobutenes are obtainable, for example, by the process of DE-A 27 02 604 by cationic polymerization of isobutene in the liquid phase in the presence of boron trifluoride as a catalyst. A disadvantage here is that the resulting polyisobutenes have a relatively high polydispersity. The polydispersity PDI is a measure of the molecular weight distribution of the resulting polymer chains and corresponds to the quotient of weight-average molecular weight M_{w} and number-average molecular weight Mₙ (PDI=M_{w}/Mₙ).

Polyisobutenes having a similarly high content of terminal double bonds, but having a narrower molecular weight distribution, are obtainable, for example, by the processes of EP-A 145 235, U.S. Pat. No. 5,408,018 and WO 99/64482, the polymerization being effected in the presence of a deactivated catalyst, for example of a complex of boron trifluoride, alcohols and/or ethers. A disadvantage here is that it is necessary to work at very low temperatures, often significantly below 0° C., which causes a high energy demand, in order actually to obtain highly reactive polyisobutenes.

EP-A 1 344 785 describes a process for preparing highly reactive polyisobutenes using a solvent-stabilized transition metal complex with weakly coordinating anions as a polymerization catalyst. Suitable metals mentioned are those of group 3 to 12 of the periodic table; manganese complexes are used in the examples. Although it is possible in this process to polymerize at reaction temperatures above 0° C., a disadvantage is that the polymerization times are unacceptably long, so that economic utilization of this process becomes unattractive.

EP-A 1 598 380 describes fluorine-element acid-donor complexes, for example HBF₄.O(CH₃)₂, as polymerization catalysts for isobutene. The starting material mentioned is isobutenic technical C₄ hydrocarbon streams such as raffinate 1.

WO 95/26814 discloses supported polymerization catalysts for isobutene polymerization which are formed by reaction of organometallic compounds, including those of aluminum or boron, for example triisobutylaluminum, with strong mineral acids or organic acids such as trifluormethanesulfonic acid, and are bonded covalently to the support material. These polymerization catalysts achieve a content of vinylidene double bonds in the polymer of up to 40 mol %. The starting material mentioned is from isobutenic technical C₄ hydrocarbon streams.

It is known that catalyst systems as used, for example, in EP-A 1 598 380 lead to a certain residual fluorine content in the product in the form of organic fluorine compounds. In order to reduce the level of such by-products or to avoid them entirely, fluorine atoms bonded directly to a metal center should be dispensed with in such a catalyst complex.

It was therefore an object of the present invention to provide a process for preparing low, medium and high molecular weight, highly reactive polyisobutene homo- or copolymers, in particular for preparing polyisobutene polymers having a number-average molecular weight Mₙ of from 500 to 1 000 000 and having a content of terminal vinylidene double bonds of at least 80 mol %, which firstly allows polymerization of isobutene or isobutenic monomer sources at not excessively low temperature, but at the same time enables distinctly shorter polymerization times. The catalyst used here should not comprise any readily eliminable fluorine functions.

The object is achieved by a process for preparing highly reactive isobutene homo- or copolymers having a number-average molecular weight Mₙ of from 500 to 1 000 000 by polymerizing isobutene from a technical C₄ hydrocarbon stream having an isobutene content of from 1 to 90% by weight in the liquid phase in the presence of a dissolved, dispersed or supported catalyst complex, which comprises using, as the catalyst complex, a protic acid compound of the general formula I

[H⁺]ₖY^{k-}.Lₓ (I)

in which
the variable Y^{k-} is a weakly coordinating k-valent anion which comprises at least one carbon-containing moiety,
L denotes neutral solvent molecules and
x is ≧0.

In the context of the present invention, isobutene homopolymers are understood to mean those polymers which, based on the polymer, are composed of isobutene to an extent of at least 98 mol %, preferably to an extent of at least 99 mol %. Accordingly, isobutene copolymers are understood to mean those polymers which comprise more than 2 mol % of monomers other than isobutene in copolymerized form.

In a preferred embodiment, the carbon-containing moieties occurring in the anion Y^{k-} are one or more aliphatic, heterocyclic or aromatic hydrocarbon radicals which have in each case from 1 to 30 carbon atoms and may comprise fluorine atoms, and/or silyl groups comprising C₁ to C₃₀ hydrocarbon radicals.

Useful aliphatic hydrocarbon radicals in the anion Y^{k-} are, for example, linear or branched alkyl radicals having from 1 to 8 carbon atoms. Examples thereof are methyl, ethyl, n-propyl, isopropyl, n-butyl, 2-butyl, isobutyl, tert-butyl, pentyl, 1-methylbutyl, 2-methylbutyl, 3-methylbutyl, 2,2-dimethylpropyl, 1-ethylpropyl, n-hexyl, 1,1-dimethyl-propyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethyl-butyl, 2,3-dimethylbutyl, 3,3-dimethylbutyl, 1-ethylbutyl, 2-ethylbutyl, 1,1,2-trimethyl-propyl, 1,2,2-trimethylpropyl, 1-ethyl-1-methylpropyl, 1-ethyl-2-methylpropyl, n-heptyl, n-octyl and 2-ethylhexyl. However, longer-chain alkyl radicals such as n-decyl, n-dodecyl, n-tridecyl, isotridecyl, n-tetradecyl, n-hexadecyl or n-octadecyl can also be used in principle.

Suitable heterocyclic aromatic or partly or fully saturated radicals which may be present in the anion Y^{k-} are, for example, pyridines, imidazoles, imidazolines, piperidines or morpholines.

Useful aromatic hydrocarbon radicals in the anion Y^{k-} are, for example, C₆- to C₁₈-aryl radicals, for example optionally substituted phenyl or tolyl, optionally substituted naphthyl, optionally substituted biphenyl, optionally substituted anthracenyl or optionally substituted phenanthrenyl. Examples of further substituents which may be present once or more than once are, for example, nitro, cyano, hydroxyl, chlorine and trichloromethyl. The number of carbon atoms mentioned for these aryl radicals comprises all carbon atoms present in these radicals, including the carbon atoms of substituents on the aryl radicals.

All aliphatic, heterocyclic or aromatic hydrocarbon radicals mentioned may be substituted by one or more fluorine atoms; as examples thereof, reference is made to the specific fluorine compounds listed in the preferred embodiments mentioned below.

For examples of silyl groups comprising C₁ to C₃₀ hydrocarbon radicals, reference is made to the specific silyl compounds listed in the preferred embodiments mentioned below.

In a particularly preferred embodiment, the protic acid catalyst complex used for the process according to the invention is a boron compound of the general formula II

[H⁺]ₘ₊₁[R¹R²R³B-(-A^{m+}-BR⁵R⁶)ₙ—R⁴]^{(m+1)-}.Lₓ (II)

in which
the variables R¹, R², R³, R⁴, R⁵ and R⁶ are each independently aliphatic, heterocyclic or aromatic fluorinated hydrocarbon radicals having in each case from 1 to 18 carbon atoms, or silyl groups comprising C₁ to C₁₈ hydrocarbon radicals,

A denotes a nitrogen-containing bridging member which forms covalent bonds to the boron atoms via its nitrogen atoms,

L denotes neutral solvent molecules,
n is 0 or 1,
m is 0 or 1 and
x is ≧0.

In the case of the absence of a bridging member A (n=0) its charge number m is also 0.

In the case of fluorohydrocarbon radicals, the variables R¹, R², R³, R⁴, R⁵ and R⁶ of the weakly coordinating anion [R¹R²R³B-(-A^{m+}-BR⁵R⁶—)ₙ—R⁴]^{(m+1)-} are each independently aliphatic, heterocyclic or aromatic fluorinated hydrocarbon radicals having in each case from 1 to 18, preferably from 3 to 18 carbon atoms. In the case of aliphatic radicals, preference is given to those having from 1 to 10, in particular from 2 to 6 carbon atoms. These aliphatic radicals may be linear, branched or cyclic. They comprise in each case from 1 to 12, in particular from 3 to 9 fluorine atoms. Typical examples of such aliphatic radicals are difluoromethyl, trifluoromethyl, 2,2-difluoroethyl, 2,2,2-trifluoroethyl, 1,2,2,2-tetrafluoroethyl, pentafluoroethyl, 1,1,1-trifluoro-2-propyl, 1,1,1-trifluoro-2-butyl, 1,1,1-trifluoro-tert-butyl and tris(trifluoromethyl)methyl.

In a preferred embodiment, the variables R¹, R², R³, R⁴, R⁵ and R⁶ are each independently C₆- to C₁₈-aryl radicals, in particular C₆- to C₉-aryl radicals, having in each case from 3 to 12 fluorine atoms, in particular from 3 to 6 fluorine atoms; very particular preference is given here to pentafluorophenyl radicals, 3- or 4-trifluoromethyl-phenyl radicals and 3,5-bis(trifluoromethyl)phenyl radicals.

In the context of the present invention, C₆- to C₁₈-aryl or C₆- to C₉-aryl is polyfluoro-phenyl or polyfluorotolyl optionally having further substitution, polyfluoronaphthyl optionally having further substitution, polyfluorobiphenyl optionally having further substitution, polyfluoroanthracenyl optionally having further substitution or polyfluoro-phenanthrenyl optionally having further substitution. Examples of further substituents which may be present once or more than once in this context are nitro, cyano, hydroxyl, chlorine and trichloromethyl. The number of carbon atoms mentioned for these aryl radicals includes all carbon atoms present in these radicals, including the carbon atoms of substituents on the aryl radicals.

In the case of silyl groups comprising C₁ to C₁₈ hydrocarbon radicals, the variables R¹, R², R³, R⁴, R⁵ and R⁶ are each independently preferably trialkylsilyl groups, where the three alkyl radicals may be different or preferably the same. Useful alkyl radicals here are in particular linear or branched alkyl radicals having from 1 to 8 carbon atoms. Examples thereof are methyl, ethyl, n-propyl, isopropyl, n-butyl, 2-butyl, isobutyl, tert-butyl, pentyl, 1-methylbutyl, 2-methylbutyl, 3-methylbutyl, 2,2-dimethylpropyl, 1-ethyl-propyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methyl-propyl, n-heptyl, n-octyl and 2-ethylhexyl. However, longer-chain alkyl radicals such as n-decyl, n-dodecyl, n-tridecyl, isotridecyl, n-tetradecyl, n-hexadecyl or n-octadecyl can also be used in principle. Trimethylsilyl and triethylsilyl radicals are very particularly suitable.

The variables R¹, R², R³, R⁴, R⁵ and R⁶ may to a slight extent additionally comprise functional groups or heteroatoms, provided that this do not impair the dominating fluorohydrocarbon character or the dominating silylhydrocarbon character of the radicals. Such functional groups or heteroatoms are, for example, further halogen atoms such as chlorine or bromine, nitro groups, cyano groups, hydroxyl groups, and C₁- to C₄-alkoxy groups such as methoxy, ethoxy, propoxy, isopropoxy, butoxy, isobutoxy and tert-butoxy. Heteroatoms may also be part of the parent hydrocarbon chains or rings, for example oxygen in the form of ether functions, for example in polyoxyalkylene chains, or nitrogen and/or oxygen as part of heterocyclic aromatic or partly or fully saturated ring systems, for example in pyridines, imidazoles, imidazolines, piperidines or morpholines. In each case, the variables R¹, R², R³, R⁴, R⁵ and R⁶ are, though, bonded covalently to the boron atoms via a carbon atom.

The variables R¹, R², R³, R⁴, R⁵ and R⁶ may all be different. However, it is also possible for a plurality or all of these variables to be the same. In particularly preferred embodiments, (in the case of n=1) all six variables R¹, R², R³, R⁴, R⁵ and R⁶ or (in the case of n=0) all four variables R¹, R², R³ and R⁴ are the same and are each penta-fluorophenyl, 3,5-bis(trifluoromethyl)phenyl, trimethylsilyl or triethylsilyl.

Typical unbridged protic acid compounds II (n=0) comprise, as the singly negatively charged anion, tetrakis(pentafluorophenyl)borane, tetrakis[3-(trifluoromethyl)phenyl]-borane, tetrakis[4-(trifluoromethyl)phenyl]borane or tetrakis[3,5-bis(trifluoromethyl)-phenyl]borane.

The nitrogen-containing bridging member A which forms covalent bonds to the boron atoms via its nitrogen atoms may, in the simplest case, be a unit of the formula —NH-derived formally from ammonia. Further examples of A are units derived from aliphatic and aromatic diamines such as 1,2-diaminomethane, 1,2-ethylenediamine, 1,3-propylenediamine, 1,4-butylenediamine, 1,2-, 1,3- or 1,4-phenylenediamine.

In a preferred embodiment, the bridging member A denotes an optionally singly positively charged five- or six-membered heterocycle unit which has at least 2 nitrogen atoms and may be saturated or unsaturated, for example pyrazolium, imidazolidine, imidazolinium, imidazolium, 1,2,3-triazolidine, 1,2,3-triazolium, 1,2,4-triazolium, tetrazolium or pyrazan. Particular preference is given to imidazolium for A.

A typical bridged protic acid compound II (n=1) comprises, as the singly negatively charged anion, the structure [(F₅C₆)₃B-imidazolium-B(C₆F₅)₃]⁻, where the imidazolium bridge in each case forms a covalent bond to one of the two boron atoms via each of its two nitrogen atoms.

In a further particularly preferred embodiment, the protic acid catalyst complex used for the process according to the invention is a compound of the general formula III

H⁺[MXₐ(OR⁷)_{b}]⁻.Lₓ (III)

in which
M is a metal atom from the group of boron, aluminum, gallium, indium and thallium,
the variables R⁷ are each independently aliphatic, heterocyclic or aromatic hydrocarbon radicals which have in each case from 1 to 18 carbon atoms and may comprise fluorine atoms, or silyl groups comprising C₁ to C₁₈ hydrocarbon radicals,
the variable X is a halogen atom,
L denotes neutral solvent molecules,
a represents integers from 0 to 3 and b represents integers from 1 to 4, where the sum of a+b has to add up to the value of 4, and
x is ≧0.

When the variables R⁷ represent aliphatic, heterocyclic or aromatic hydrocarbon radicals having in each case from 1 to 18 carbon atoms, they preferably comprise one or more fluorine atoms.

In the case of fluorohydrocarbon radicals, the variables R⁷ of the weakly coordinating anion [MXₐ(OR⁷)_{b}]⁻ are each independently aliphatic, heterocyclic or aromatic fluorinated hydrocarbon radicals having in each case from 1 to 18, preferably from 1 to 13 carbon atoms. In the case of aliphatic radicals, particular preference is given to those having from 1 to 10, in particular from 1 to 6 carbon atoms. These aliphatic radicals may be linear, branched or cyclic. They comprise in each case from 1 to 12, in particular from 3 to 9 fluorine atoms. Typical examples of such aliphatic radicals are difluoromethyl, trifluoromethyl, 2,2-difluoroethyl, 2,2,2-trifluoroethyl, 1,2,2,2-tetrafluoro-ethyl, pentafluoroethyl, 1,1,1-trifluoro-2-propyl, 1,1,1-trifluoro-2-butyl, 1,1,1-trifluoro-tert-butyl, and in particular tris(trifluoromethyl)methyl.

In the case of aromatic radicals, the variables R⁷ are each independently preferably C₆- to C₁₈-aryl radicals, in particular C₆- to C₉-aryl radicals, having in each case from 3 to 12 fluorine atoms, in particular from 3 to 6 fluorine atoms; preference is given here to pentafluorophenyl radicals, 3- or 4-(trifluoromethyl)phenyl radicals and 3,5-bis(trifluoro-methyl)phenyl radicals.

In the context of the present invention, such C₆- to C₁₈-aryl or C₆— to C₉-aryl is polyfluorophenyl or polyfluorotolyl optionally having further substitution, polyfluoro-naphthyl optionally having further substitution, polyfluorobiphenyl optionally having further substitution, polyfluoroanthracenyl optionally having further substitution or polyfluorophenanthrenyl optionally having further substitution. Examples of further substituents which may be present once or more than once in this context are, for example, nitro, cyano, hydroxyl, chlorine and trichloromethyl. The number of carbon atoms mentioned for these aryl radicals comprises all carbon atoms present in these radicals, including the carbon atoms of substituents on the aryl radicals.

In the case of silyl groups comprising C₁ to C₁₈ hydrocarbon radicals, the variables R⁷ are each independently preferably trialkylsilyl groups, where the three alkyl radicals may be different or preferably the same. Useful alkyl radicals here are in particular linear or branched alkyl radicals having from 1 to 8 carbon atoms. Examples thereof are methyl, ethyl, n-propyl, isopropyl, n-butyl, 2-butyl, isobutyl, tert-butyl, pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethyl-butyl, 2,3-dimethylbutyl, 3,3-dimethylbutyl, 1-ethylbutyl, 2-ethylbutyl, 1,1,2-trimethyl-propyl, 1,2,2-trimethylpropyl, 1-ethyl-1-methylpropyl, 1-ethyl-2-methylpropyl, n-heptyl, n-octyl and 2-ethylhexyl. However, longer-chain alkyl radicals such as n-decyl, n-dodecyl, n-tridecyl, isotridecyl, n-tetradecyl, n-hexadecyl or n-octadecyl can also be used in principle. Trimethylsilyl and triethylsilyl radicals are particularly suitable.

The variables R⁷ may, to a small extent, additionally comprise functional groups or heteroatoms, provided that this do not impair the dominating fluorohydrocarbon character or the dominating silylhydrocarbon character of the radicals. Such functional groups or heteroatoms are, for example, further halogen atoms such as chlorine or bromine, nitro groups, cyano groups, hydroxyl groups, and also C₁- to C₄-alkoxy groups such as methoxy, ethoxy, propoxy, isopropoxy, butoxy, isobutoxy and tert-butoxy. Heteroatoms may also be part of the parent hydrocarbon chains or rings, for example oxygen in the form of ether functions, for example in polyoxyalkylene chains, or nitrogen and/or oxygen as part of heterocyclic aromatic or partly or fully saturated ring systems, for example in pyridines, imidazoles, imidazolines, piperidines or morpholines.

In a preferred embodiment, the variables R⁷ are each independently C₁- to C₁₈-alkyl radicals having from 1 to 12 fluorine atoms, in particular tris(trifluoromethyl)methyl radicals, or C₆- to C₁₈-aryl radicals having from 3 to 6 fluorine atoms, in particular pentafluorophenyl radicals, 3- or 4-(trifluoromethyl)phenyl radicals or 3,5-bis(trifluoro-methyl)phenyl radicals.

When a plurality of variables R⁷ are present in the compound I, they may all be different. However, it is also possible for a plurality of or all of these variables to be the same. In a particularly preferred embodiment, all variables R⁷ are the same and are each tris(trifluoromethyl)methyl radicals, pentafluorophenyl radicals, 3- or 4-(trifluoro-methyl)phenyl radicals or 3,5-bis(trifluoromethyl)phenyl radicals.

The variables R⁷ are part of corresponding alkoxylate units —OR⁷ which, together with possible halogen atoms X, are localized as substituents on the metal atom M and are generally joined to it by a covalent bond. The number b of these alkoxylate units —OR⁷ is preferably from 2 to 4, in particular 4, and the number a of possible halogen atoms X is preferably from 0 to 2, in particular 0, where the sum of a+b has to add up to the value of 4.

The metal atoms M are the metals of group IIIA (corresponding to group 13 in the new nomenclature) of the Periodic Table of the Elements. Among these, preference is given to boron and aluminum, especially aluminum.

The halogen atoms X are the nonmetals of group VIIA (corresponding to group 17 in the new nomenclature) of the Periodic Table of the Elements, i.e. fluorine, chlorine, bromine, iodine and astatine. Among these, preference is given to fluorine and especially chlorine.

The compounds of the general formula I, II and III may also comprise neutral solvent molecules L. These solvent molecules L may also be referred to as ligands or donors. Typically up to x=12 such solvent molecules L, in particular x=from 2 to 8, may be present per formula unit I or II or III. They are preferably selected from open-chain and cyclic ethers, especially from di-C₁- to C₃-alkyl ethers, ketones, thiols, organic sulfides, sulfones, sulfoxides, sulfonic esters, organic sulfates, phosphines, phosphine oxides, organic phosphites, organic phosphates, phosphoramides, carboxylic esters, carboxamides, and alkyl nitriles and aryl nitriles.

The solvent molecules L are solvent molecules which can form coordinative bonds with the central metal atoms. They are molecules which are typically used as solvents but at the same time possess at least one dative moiety, for example a free electron pair, which can enter into a coordinative bond to a central metal. Preferred solvent molecules L are those which, on the one hand, bind coordinatively to the central metal, but, on the other hand, are not strong Lewis bases, so that they can be displaced readily from the coordination sphere of the central metal in the course of the polymerization.

One function of the solvent molecules L is to stabilize the protons possibly present in the compounds I, for example in the case of ethers as diethyl etherates [H(OEt₂)₂]⁺.

Examples of open-chain and cyclic ethers for solvent molecules L are diethyl ether, dipropyl ether, diisopropyl ether, methyl tert-butyl ether, ethyl tert-butyl ether, tetrahydrofuran and dioxane. In the case of open-chain ethers, preference is given to di-C₁- to C₃-alkyl ethers, in particular symmetrical di-C₁- to C₃-alkyl ethers.

Suitable ketones for solvent molecules L are, for example, acetone, ethyl methyl ketone, acetoacetone or acetophenone.

Suitable thiols, organic sulfides (thioethers), sulfones, sulfoxides, sulfonic esters and organic sulfates for sulfur-containing solvent molecules L are, for example, relatively long-chain mercaptans such as dodecyl mercaptan, dialkyl sulfides, dialkyl disulfides, dimethyl sulfone, dimethyl sulfoxide, methyl methylsulfonate or dialkyl sulfates such as dimethyl sulfate.

Suitable phosphines, phosphine oxides, organic phosphites, organic phosphates and phosphoramides for phosphorus-containing solvent molecules L are, for example, triphenylphosphine, triphenylphosphine oxide, trialkyl, triaryl or mixed aryl/alkyl phosphites, trialkyl, triaryl or mixed aryl/alkyl phosphates or hexamethyl-phosphoramide.

Suitable carboxylic esters for solvent molecules L are, for example, methyl or ethyl acetate, methyl or ethyl propionate, methyl or ethyl butyrate, methyl or ethyl caproate or methyl or ethyl benzoate.

Suitable carboxamides for solvent molecules L are, for example, formamide, dimethyl-formamide, acetamide, dimethylacetamide, propionamide, benzamide or N,N-dimethyl-benzamide.

Suitable alkyl nitriles and aryl nitriles for solvent molecules L are in particular C₁- to C₈-alkyl nitriles, in particular C₁- to C₄-alkyl nitriles, for example acetonitrile, propionitrile, butyronitrile or pentyl nitrile, and also benzonitrile.

In the protic acid compounds of the general formula I, preferably all L each represent the same solvent molecule.

The compounds of the general formula I, II and III may be generated in situ and be used in this form as catalysts for the inventive isobutene polymerization. However, they can also be prepared as pure substances from their preparatively readily available salts and used in accordance with the invention. In this form, they are generally storage-stable over a prolonged period.

For instance, the protic acid compounds of the general formula II may be prepared as pure substances from salts which are preparatively readily obtainable and some of which are therefore commercially available, for example the silver salt, and used in accordance with the invention. To prepare the protic acid compounds I, for example, the appropriate silver salt in a protic, moderately polar solvent is admixed with hydrogen halide, and the sparingly soluble silver halide thus eliminated is removed.

For instance, to prepare the compounds III, it is possible, for example, to react a four-fold excess of an alcohol of the formula R⁷OH with lithium aluminum hydride in an aprotic solvent to give the corresponding lithium salt. The resulting lithium salt can be admixed with hydrogen halide in a subsequent step in order to give rise to the compound III with elimination of lithium halide.

The polymerization process according to the invention is suitable for preparing low, medium and high molecular weight, highly reactive isobutene homo- or copolymers. Preferred comonomers in this context are styrene, styrene derivatives, especially α-methylstyrene and 4-methylstyrene, styrene- and styrene derivative-containing monomer mixtures, alkadienes such as butadiene and isoprene, and mixtures thereof. In particular, the monomers used in the polymerization process according to the invention are isobutene, styrene or mixtures thereof.

For the use of isobutene or an isobutenic monomer mixture as the monomer to be polymerized, the isobutene source used here is a technical C₄ hydrocarbon stream having an isobutene content of from 1 to 80% by weight. Suitable for this purpose are in particular C₄ raffinates (raffinate 1, raffinate 1P and raffinate 2), C₄ cuts from isobutane dehydrogenation, C₄ cuts from steamcrackers (after butadiene extraction or partly hydrogenated) and from FCC crackers (fluid catalyzed cracking), provided that they have been substantially freed of 1,3-butadiene present therein. Suitable C₄ hydrocarbon streams comprise generally less than 500 ppm, preferably less than 200 ppm, of butadiene. The presence of 1-butene and of cis- and trans-2-butene is substantially uncritical. Typically, the isobutene concentration in the C₄ hydrocarbon streams is in the range from 30 to 70% by weight, in particular from 40 to 60% by weight, raffinate 2 and the FCC streams having lower isobutene concentrations but being equally suitable for the process according to the invention. The isobutenic monomer mixture may comprise small amounts of contaminants such as water, carboxylic acids or mineral acids, without there being critical yield or selectivity losses. It is appropriate to prevent enrichment of these impurities by removing such harmful substances from the isobutenic monomer mixture, for example by adsorption on solid adsorbents such as activated carbon, molecular sieves or ion exchangers.

Typically, the content of isobutene in a raffinate 1 stream is from 30 to 50% by weight, that of 1-butene is from 10 to 50% by weight, that of cis- and trans-2-butene is from 10 to 40% by weight and that of butanes is from 2 to 35% by weight.

Typically, the content of isobutene in a raffinate 1P stream is from 35 to 60% by weight, that of 1-butene is from 1 to 15% by weight, that of cis- and trans-2-butene is from 15 to 50% by weight and that of butanes is from 2 to 40% by weight.

Typically, the content of isobutene in a raffinate 2 stream is from 0.5 to 10% by weight, that of 1-butene is from 15 to 60% by weight, that of cis- and trans-2-butene is from 5 to 50% by weight and that of butanes is from 5 to 45% by weight.

Typically, the content of isobutene in a C₄ cut from isobutane dihydrogenation is from 20 to 70% by weight, that of 1-butene is <1% by weight, that of cis- and trans-2-butene is <1% by weight and that of butanes is from 30 to 80% by weight.

Typically, the content of isobutene in a C₄ cut from steamcrackers after butadiene extraction is from 30 to 50% by weight, that of 1-butene is from 10 to 30% by weight, that of cis- and trans-2-butene is from 10 to 30% by weight and that of butanes is from 5 to 20% by weight.

Typically, the content of isobutene in a partly hydrogenated C₄ cut from the steam-cracker (HC4 stream) is from 10 to 45% by weight, that of 1-butene is from 15 to 60% by weight, that of cis- and trans-2-butene is from 5 to 50% by weight and that of butanes is from 5 to 45% by weight.

Typically, the content of isobutene in an FCC stream is from 10 to 30% by weight, that of 1-butene is from 5 to 25% by weight, that of cis- and trans-2-butene is from 10 to 40% by weight and that of butanes is from 30 to 70% by weight.

In a preferred embodiment, the technical C₄ hydrocarbon stream used in the process according to the invention comprises from 30 to 70% by weight of isobutene, from 1 to 50% by weight of 1-butene, from 1 to 50% by weight of cis- and trans-2-butene, from 2 to 40% by weight of butanes and up to 1000 ppm by weight of butadiene.

In a particularly preferred embodiment, the process according to the invention to prepare highly reactive isobutene homo- or copolymers is performed by polymerizing isobutene from raffinate 1 or raffinate 1P as a technical C₄ hydrocarbon stream. In this case, raffinate 1 and raffinate 1P typically have the above-specified compositions and a content of butadiene of not more than 1000 ppm by weight.

It is possible by the process according to the invention to react monomer mixtures of isobutene or of the isobutenic hydrocarbon mixture with olefinically unsaturated monomers which are copolymerizable with isobutene. When monomer mixtures of isobutene with suitable comonomers are to be copolymerized, the monomer mixture comprises preferably at least 5% by weight, more preferably at least 10% by weight and in particular at least 20% by weight of isobutene, and preferably at most 95% by weight, more preferably at most 90% by weight and in particular at most 80% by weight of comonomers.

Useful copolymerizable monomers include vinylaromatics such as styrene and α-methylstyrene, C₁-C₄-alkylstyrenes such as 2-, 3- and 4-methylstyrene and 4-tert-butylstyrene, alkadienes such as butadiene and isoprene, and isoolefins having from 5 to 10 carbon atoms, such as 2-methylbutene-1,2-methylpentene-1,2-methylhexene-1,2-ethylpentene-1,2-ethylhexene-1 and 2-propylheptene-1. Useful comonomers are also olefins which have a silyl group, such as 1-trimethoxysilyl-ethene, 1-(trimethoxy-silyl)propene, 1-(trimethoxysilyl)-2-methylpropene-2,1-[tri(methoxyethoxy)silyl]ethene, 1-[tri(methoxyethoxy)silyl]propene, and 1-[tri(methoxyethoxy)silyl]-2-methylpropene-2, and also vinyl ethers such as tert-butyl vinyl ether.

When copolymers are to be prepared with the process according to the invention, the process can be configured so as to form preferentially random polymers or preferentially block copolymers. To prepare block copolymers, the different monomers can, for example, be fed successively to the polymerization reaction, in which case the second monomer is added in particular only when the first comonomer has already been polymerized at least partly. In this way, diblock, triblock and also higher block copolymers are obtainable, which, depending on the sequence of monomer addition, have a block of one or another comonomer as the terminal block. In some cases, block copolymers are also formed when all comonomers are fed simultaneously to the polymerization reaction but one polymerizes significantly more rapidly than the other or the others. This is the case especially when isobutene and a vinylaromatic compound, especially styrene, are copolymerized in the process according to the invention. This preferably forms block copolymers with a terminal polyisobutene block. This is attributable to the fact that the vinylaromatic compound, especially styrene, polymerizes significantly more rapidly than isobutene.

The polymerization can be effected either continuously or batchwise. Continuous processes can be carried out in analogy to known prior art processes for continuously polymerizing isobutene in the presence of Lewis acid catalysts in the liquid phase.

The process according to the invention is suitable both for performance at low temperatures, for example at from −78 to 0° C., and at higher temperatures, i.e. at at least 0° C., for example at from 0 to 100° C. For economic reasons in particular, the polymerization is preferably carried out at least 0° C., for example at from 0 to 100° C., more preferably at from 20 to 60° C., in order to minimize the energy and material consumption which is required for cooling. However, it can be carried out just as efficiently at lower temperatures, for example at from −78 to <0° C., preferably at from −40 to −10° C.

When the polymerization is effected at or above the boiling point of the monomer or monomer mixture to be polymerized, it is preferably carried out in pressure vessels, for example in autoclaves or in pressure reactors.

Preference is given to performing the polymerization in the presence of an inert diluent. The inert diluent used should be suitable for reducing the increase in the viscosity of the reaction solution which generally occurs during the polymerization reaction to just an extent that the removal of the heat of reaction which arises can be ensured. Suitable diluents are those solvents or solvent mixtures which are inert toward the reagents used. Suitable diluents are, for example, aliphatic hydrocarbons such as butane, pentane, hexane, heptane, octane and isooctane, cycloaliphatic hydrocarbons such as cyclopentane and cyclohexane, aromatic hydrocarbons such as benzene, toluene and the xylenes, and halogenated hydrocarbons such as methyl chloride, dichloromethane and trichloromethane, and also mixtures of the aforementioned diluents. Preference is given to using at least one halogenated hydrocarbon, if appropriate in a mixture with at least one of the aforementioned aliphatic or aromatic hydrocarbons. In particular, dichloromethane is used. Preference is given to freeing the diluents of impurities such as water, carboxylic acids or mineral acids before use, for example by adsorption on solid adsorbents such as activated carbon, molecular sieves or ion exchangers.

Preference is given to performing the polymerization under substantially aprotic, especially under anhydrous reaction conditions. Aprotic or anhydrous reaction conditions are understood to mean that the water content (or the content of protic impurities) in the reaction mixture is less than 50 ppm and in particular less than 5 ppm. In general, the feedstocks will therefore generally be dried before use by physical and/or by chemical measures. In particular, it has been found to be useful to admix the aliphatic or alicyclic hydrocarbons used as solvents, after customary prepurification and predrying, with an organometallic compound, for example an organolithium, organo-magnesium or organoaluminum compound, in an amount which is sufficient to remove the water traces from the solvent. The solvent thus treated is then preferably condensed directly into the reaction vessel. It is also possible to proceed in a similar manner with the monomers to be polymerized, especially with isobutene or with the isobutenic mixtures. Drying with other customary desiccants such as molecular sieves or predried oxides, such as aluminum oxide, silicon dioxide, calcium oxide or barium oxide, is also suitable. The halogenated solvents for which drying with metals such as sodium or potassium or with metal alkyls is not an option are freed of water (traces) with desiccants suitable for this purpose, for example with calcium chloride, phosphorus pentoxide or molecular sieve. It is also possible in an analogous manner to dry those feedstocks for which a treatment with metal alkyls is likewise not an option, for example vinylaromatic compounds.

The polymerization of the isobutene or of the isobutenic starting material generally proceeds spontaneously when the catalyst complex (i.e. the compound I or preferably II or preferably III) is contacted with the monomer at the desired reaction temperature. The procedure here can be to initially charge the monomer, if appropriate in the solvent, to bring it to reaction temperature and subsequently to add the catalyst complex, for example as a loose bed. The procedure may also be to initially charge the catalyst complex (for example as a loose bed or as a fixed bed), if appropriate in the solvent, and then to add the monomer. In that case, the start of polymerization is that time at which all reactants are present in the reaction vessel. The catalyst complex may dissolve partly or fully in the reaction medium or be present in the form of a dispersion. Alternatively, the catalyst complex may also be used in supported form.

When the catalyst complex is to be used in supported form, it is contacted with a suitable support material and thus converted to a heterogenized form. The contacting is effected, for example, by impregnation, soaking, spraying, brushing or related techniques. The contacting also comprises techniques of physisorption. The contacting can be effected at standard temperature and standard pressure, or else at higher temperatures and/or pressures.

As a result of the contacting, the catalyst complexes enters into a physical and/or chemical interaction with the support material. Such interaction mechanisms are firstly the exchange of one or more neutral solvent molecules L and/or of one or more charged structural units of the catalyst complex for neutral or correspondingly charged moieties, molecules or ions which are incorporated in the support material or adhere on it. Moreover, the weakly coordinating anion Y^{k-} can be exchanged for a corresponding negatively charged moiety, or an anion from the support material or the positively charged proton from the catalyst complex can be exchanged for a correspondingly positively charged cation from the support material (for example an alkali metal ion). In addition to such true ion exchange processes or instead of them, it is also possible for weaker electrostatic interaction to occur. Finally, the catalyst complex can also be fixed onto the support material by means of covalent bonds, for example by reaction with hydroxyl groups or silanol groups which reside in the interior of the support material or preferably on the surface.

Essential factors for suitability as a support material in the context of the present invention are also its specific surface size and its porosity properties. In this context, mesoporous support materials have been found to be particularly advantageous. Mesoporous support materials generally have an internal surface area of from 100 to 3000 m²/g, in particular from 200 to 2500 m²/g, and pore diameters of from 0.5 to 50 nm, in particular from 1 to 20 nm.

Suitable support materials are in principle all solid inert substances with large surface area, which may typically serve as a substrate or skeleton for active substance, in particular for catalysts. Typical inorganic substance classes for such support materials are activated carbon, alumina, silica gel, kieselguhr, talc, kaolin, clays and silicates. Typical organic substance classes for such support materials are crosslinked polymer matrices such as crosslinked polystyrenes and crosslinked polymethacrylates, phenol-formaldehyde resins or polyalkylamine resins.

The support material is preferably selected from molecular sieves and ion exchangers.

The ion exchangers used may be cationic, anionic or amphoteric ion exchangers. Preferred organic or inorganic matrix types for such ion exchangers in this context are divinylbenzene-wetted polystyrenes (crosslinked divinylbenzene-styrene copolymers), divinylbenzene-crosslinked polymethacrylates, phenol-formaldehyde resins, polyalkylamine resins, hydrophilized cellulose, crosslinked dextran, crosslinked agarose, zeolites, montmorillonites, attapulgites, bentonites, aluminum silicates and acidic salts of polyvalent metal ions, such as zirconium phosphate, titanium tungstate or nickel hexacyanoferrate(II). Acidic ion exchangers bear typically carboxylic acid, phosphonic acid, sulfonic acid, carboxymethyl or sulfoethyl groups. Basic ion exchangers comprise usually primary, secondary or tertiary amino groups, quaternary ammonium groups, aminoethyl or diethylaminoethyl groups.

Molecular sieves have a strong adsorption capacity for gases, vapors and dissolved substances, and are generally also usable for ion exchange processes. Molecular sieves have generally uniform pore diameters which are in the order of magnitude of the diameters of molecules, and large internal surface areas, typically from 600 to 700 m²/g. The molecular sieves used in the context of the present invention may in particular be silicates, aluminum silicates, zeolites, silicoaluminophosphates and/or carbon molecular sieves.

Ion exchangers and molecular sieves having an internal surface area of from 100 to 3000 m²/g, in particular from 200 to 2500 m²/g, and pore diameters of from 0.5 to 50 nm, in particular from 1 to 20 nm, are particularly advantageous.

The support material is preferably selected from molecular sieves of types H-AIMCM-41, H-AIMCM-48, NaAIMCM-41 and NaAIMCM-48. These molecular sieve types are silicates or aluminum silicates, on whose inner surface silanol groups which may be of significance for the interaction with the catalyst complex adhere. However, the interaction is thought to be based mainly on the partial exchange of protons and/or sodium ions.

In the case of use as a solution, as a dispersion or in supported form, the catalyst complex effective as the polymerization catalyst is used in such an amount that it, based on the amounts of monomers used, is present in the polymerization medium in a molar ratio of preferably from 1:10 to 1:1 000 000, in particular from 1:10 000 to 1:500 000 and in particular from 1:5000 to 1:100 000.

The concentration (“loading”) of the catalyst complex in the support material is in the range from preferably 0.005 to 20% by weight, in particular from 0.01 to 10% by weight and especially from 0.1 to 5% by weight.

The catalyst complex effective as a polymerization catalyst is present in the polymerization medium, for example, as a loose bed, as a fluidized bed, as a fluid bed or as a fixed bed. Suitable reactor types for the polymerization process according to the invention are accordingly typically stirred vessel reactors, loop reactors, tubular reactors, fluidized bed reactors, fluidized layer reactors, stirred tank reactors with and without solvent, fluid bed reactors, continuous fixed bed reactors and batchwise fixed bed reactors (batchwise mode).

To prepare copolymers, the procedure may be to initially charge the monomers, if appropriate in the solvent, and then to add the catalyst complex, for example as a loose bed. The reaction temperature can be established before or after the addition of the catalyst complex. The procedure may also be to initially charge at first only one of the monomers, if appropriate in the solvent, then to add the catalyst complex and, only after a certain time, for example when at least 60%, at least 80% or at least 90% of the monomer has reacted, to add the further monomer(s). Alternatively, the catalyst complex can be initially charged, for example as a loose bed, if appropriate in the solvent, then the monomers can be added simultaneously or successively and then the desired reaction temperature can be established. In that case, the start of polymerization is that time at which the catalyst complex and at least one of the monomers are present in the reaction vessel.

In addition to the batchwise procedure described here, it is also possible to configure the polymerization as a continuous process. In this case, the feedstocks, i.e. the monomer(s) to be polymerized, if appropriate the solvent and if appropriate the catalyst complex (for example as a loose bed) are fed continuously to the polymerization reaction and reaction product is withdrawn continuously, so that more or less steady-state polymerization conditions are established in the reactor. The monomer(s) to be polymerized may be fed as such, diluted with a solvent or as a monomer-containing hydrocarbon stream.

To terminate the reaction, the reaction mixture is preferably deactivated, for example by adding a protic compound, in particular by adding water, alcohols such as methanol, ethanol, n-propanol and isopropanol or mixtures thereof with water, or by adding an aqueous base, for example an aqueous solution of an alkali metal or alkaline earth metal hydroxide such as sodium hydroxide, potassium hydroxide, magnesium hydroxide or calcium hydroxide, of an alkali metal or alkaline earth metal carbonate such as sodium carbonate, potassium carbonate, magnesium carbonate or calcium carbonate, or of an alkali metal or alkaline earth metal hydrogencarbonate such as sodium hydrogencarbonate, potassium hydrogencarbonate, magnesium hydrogencarbonate or calcium hydrogencarbonate.

In a preferred embodiment of the invention, the process according to the invention serves to prepare highly reactive isobutene homo- or copolymers having a content of terminal vinylidene double bonds (α-double bonds) of at least 80 mol %, preferably of at least 85 mol %, more preferably of at least 90 mol % and in particular of at least 95 mol %, for example of about 100 mol %. In particular, it serves to prepare highly reactive copolymers which are formed from monomers comprising isobutene and at least one vinylaromatic compound and a content of terminal vinylidene double bonds (α-double bonds) of at least 80 mol %, preferably of at least 85 mol %, more preferably of at least 90 mol % and in particular of at least 95 mol %, for example of about 100 mol %.

In the case of copolymerization of isobutene or isobutenic hydrocarbon cuts with at least one vinylaromatic compound, block copolymers form preferentially even when the comonomers are added simultaneously, in which case the isobutene block generally constitutes the terminal block, i.e. the block formed last.

Accordingly, the process according to the invention serves, in a preferred embodiment, to prepare highly reactive isobutene-styrene copolymers. The highly reactive isobutene-styrene copolymers preferably have a content of terminal vinylidene double bonds (α-double bonds) of at least 80 mol %, more preferably of at least 85 mol %, even more preferably of at least 90 mol % and in particular of at least 95 mol %, for example of about 100 mol %.

To prepare such copolymers, isobutene or an isobutenic hydrocarbon cut is copolymerized with at least one vinylaromatic compound, especially styrene. More preferably, such a monomer mixture comprises from 5 to 95% by weight, more preferably from 30 to 70% by weight of styrene.

The highly reactive isobutene homo- or copolymers, especially isobutene homopolymers, prepared by the process according to the invention preferably have a polydispersity (PDI=M_{w}/Mₙ) of from 1.0 to 3.0, in particular of at most 2.0, preferably of from 1.0 to 2.0, more preferably of from 1.0 to 1.8 and in particular of from 1.0 to 1.5.

The highly reactive isobutene homo- or copolymers prepared by the process according to the invention preferably have a number-average molecular weight Mₙ of from 500 to 1 000 000, more preferably from 500 to 50 000, even more preferably from 500 to 5000 and in particular from 800 to 2500. Isobutene homopolymers especially even more preferably have a number-average molecular weight Mₙ of from 500 to 50 000 and in particular from 500 to 5000, for example of about 1000 or of about 2300.

The process according to the invention successfully polymerizes isobutene and isobutenic monomer mixtures which are polymerizable under cationic conditions and are based on technical C₄ hydrocarbon streams as feedstock material with high conversions within short reaction times even at relatively high polymerization temperatures. Highly reactive isobutene homo- or copolymers are obtained with a high content of terminal vinylidene double bonds and with a quite narrow molecular weight distribution. As a result of the use of less volatile fluorine compounds in smaller amounts in comparison to boron trifluoride and boron trifluoride adducts as polymerization catalysts, wastewater and environment are polluted less. Moreover, virtually no residual fluorine content occurs in the product in the form of organic fluorine compounds.

The present invention is illustrated in detail by the examples which follow.

### EXAMPLE 1

Polymerization of raffinate 1 with the protic acid compound made from the singly negatively charged tetrakis[3,5-bis(trifluoromethyl)phenyl]borane anion (catalyst A)

40 ml of a technical C₄ hydrocarbon stream (raffinate 1), comprising 40% by weight of isobutene, were condensed into 120 ml of a mixture of equal parts by volume of n-hexane and dichloromethane. After cooling to −40° C., 200 mg of catalyst A were added under protective gas atmosphere. Within 10 minutes, the temperature rose to −30° C. After a total of 45 minutes of polymerization time, quenching was effected by adding 10 ml of methanol, and the reaction product was taken up in further methanol and washed. After the solvents had been distilled off under reduced pressure, 6.4 g of polyisobutene were obtained with a number-average molecular weight Mₙ of 1160, a polydispersity of 2.0 and a content of terminal vinylidene double bonds of 91 mol %.

### EXAMPLE 2

Polymerization of raffinate 1 with the protic acid compound made from the singly negatively charged tetrakis[3,5-bis(trifluoromethyl)phenyl]borane anion (catalyst A)

40 ml of a technical C₄ hydrocarbon stream (raffinate 1), comprising 40% by weight of isobutene, were condensed into 120 ml of a mixture of equal parts by volume of n-hexane and dichloromethane. After cooling to −30° C., 200 mg of catalyst A were added under protective gas atmosphere. Within 10 minutes, the temperature rose to −20° C. After a total of 30 minutes of polymerization time, quenching was effected by adding 10 ml of methanol, and the reaction product was taken up in further methanol and washed. After the solvents had been distilled off under reduced pressure, at a conversion of 25% (based on isobutene), polyisobutene was obtained with a number-average molecular weight Mₙ of 1200, a polydispersity of 1.9 and a content of terminal vinylidene double bonds of 90 mol %.

### EXAMPLE 3

Continuous polymerization of a technical isobutene/1-butene mixture with the protic acid compound made from the singly negatively charged tetrakis[3,5-bis(trifluoro-methyl)phenyl]borane anion (catalyst A)

1.78 mol/l (based on isobutene) of a technical mixture of isobutene and 1-butene in a molar ratio of 87.5:12.5 and 0.05 mmol/l (based on the catalyst) of a solution of catalyst A in dichloromethane were polymerized in a customary continuous laboratory polymerization apparatus at −30° C. The polymerization time was 30 minutes. Quenching was effected by adding 10 ml of methanol, and the reaction product was taken up in further methanol and washed. After the solvents had been distilled off under reduced pressure, at a conversion of 87% (based on isobutene), polyisobutene was obtained with a number-average molecular weight Mₙ of 1100, a polydispersity of 2.8 and a content of terminal vinylidene double bonds of 87 mol %.

### EXAMPLE 4

Continuous polymerization of a technical isobutene/1-butene mixture with the protic acid compound made from the singly negatively charged tetrakis[3,5-bis(trifluoro-methyl)phenyl]borane anion (catalyst A)

1.78 mol/l (based on isobutene) of a technical mixture of isobutene and 1-butene in a molar ratio of 50:50 and 0.05 mmol/l (based on the catalyst) of a solution of catalyst A in dichloromethane were polymerized in a customary continuous laboratory polymerization apparatus at −30° C. The polymerization time was 30 minutes. Quenching was effected by adding 10 ml of methanol, and the reaction product was taken up in further methanol and washed. After the solvents had been distilled off under reduced pressure, at a conversion of 90% (based on isobutene), polyisobutene was obtained with a number-average molecular weight Mn of 1000, a polydispersity of 2.7 and a content of terminal vinylidene double bonds of 90 mol %.

### EXAMPLE 5

Polymerization of raffinate 1 with the protic acid compound of the formula [H(OEt₂)₂]+{Al[OC(CF₃)₃]₄}⁻ present as the diethyl etherate (catalyst B)

40 ml of a technical C₄ hydrocarbon stream (raffinate 1), comprising 40% by weight of isobutene, were condensed into 120 ml of a mixture of equal parts by volume of n-hexane and dichloromethane. After cooling to −40° C., 100 mg of catalyst A were added under protective gas atmosphere. Within 10 minutes, the temperature rose to −30° C. After a total of 45 minutes of polymerization time, quenching was effected by adding 10 ml of methanol, and the reaction product was taken up in further methanol and washed. After the solvents had been distilled off under reduced pressure, 1.7 g of polyisobutene were obtained with a number-average molecular weight Mₙ of 2500, a polydispersity of 2.7 and a content of terminal vinylidene double bonds of 90 mol %.

### EXAMPLE 6

Polymerization of raffinate 1 with the protic acid compound of the formula [H]⁺{Al[OC(CF₃)₃]₄}⁻ (catalyst C)

40 ml of a technical C₄ hydrocarbon stream (raffinate 1), comprising 40% by weight of isobutene, were condensed into 120 ml of a mixture of equal parts by volume of n-hexane and dichloromethane. After cooling to −30° C., 200 mg of catalyst C were added under protective gas atmosphere. Within 10 minutes, the temperature rose to −20° C. After a total of 30 minutes of polymerization time, quenching was effected by adding 10 ml of methanol, and the reaction product was taken up in further methanol and washed. After the solvents had been distilled off under reduced pressure, at a conversion of 20% (based on the isobutene), polyisobutene was obtained with a number-average molecular weight Mₙ of 2500, a polydispersity of 2.7 and a content of terminal vinylidene double bonds of 90 mol %.

1-9. (canceled)

10. A process for preparing highly reactive isobutene homo- or copolymers having a number-average molecular weight Mₙ of from 500 to 5000 by polymerizing isobutene from a technical C₄ hydrocarbon stream having an isobutene content of from 1 to 90% by weight in the liquid phase in the presence of a dissolved, dispersed or supported catalyst complex, which comprises using, as the catalyst complex, a protic acid compound of the general formula I
[H⁺]ₖY^{k-}.Lₓ (I)
in which
the variable Y^{k-} is a weakly coordinating k-valent anion which comprises at least one carbon-containing moiety,
L denotes neutral solvent molecules and
x is ≧0.

11. The process according to claim 10, wherein the carbon-containing moieties occurring in the anion Y^{k-} are one or more aliphatic, heterocyclic or aromatic hydrocarbon radicals which have in each case from 1 to 30 carbon atoms and may comprise fluorine atoms, and/or silyl groups comprising C₁ to C₃₀ hydrocarbon radicals.

12. The process according to claim 10, wherein the protic acid catalyst complex is a boron compound of the general formula II
[H⁺]ₘ₊₁[R¹R²R³B-(-A^{m+}-BR⁵R⁶—)ₙ—R4]^{(m+1)}—.Lₓ (II)
in which
the variables R¹, R², R³, R⁴, R⁵ and R⁶ are each independently aliphatic, heterocyclic or aromatic fluorinated hydrocarbon radicals having in each case from 1 to 18 carbon atoms, or silyl groups comprising C₁ to C₁₈ hydrocarbon radicals,
A denotes a nitrogen-containing bridging member which forms covalent bonds to the boron atoms via its nitrogen atoms,
L denotes neutral solvent molecules,
n is 0 or 1,
m is 0 or 1 and
x is ≧0.

13. The process according to claim 10, wherein the protic acid catalyst complex is a compound of the general formula III
H+[MXₐ(OR⁷)_{b}]⁻.Lₓ (III)
in which
M is a metal atom from the group of boron, aluminum, gallium, indium and thallium,
the variables R⁷ are each independently aliphatic, heterocyclic or aromatic hydrocarbon radicals which have in each case from 1 to 18 carbon atoms and may comprise fluorine atoms, or silyl groups comprising C₁ to C₁₈ hydrocarbon radicals,
the variable X is a halogen atom,
L denotes neutral solvent molecules,
a represents integers from 0 to 3 and b represents integers from 1 to 4, where the sum of a+b has to add up to the value of 4, and
x is ≧0.

14. The process according to claim 10, wherein the neutral solvent molecules are selected from open-chain and cyclic ethers, especially from di-C₁- to C₃-alkyl ethers, ketones, thiols, organic sulfides, sulfones, sulfoxides, sulfonic esters, organic sulfates, phosphines, phosphine oxides, organic phosphites, organic phosphates, phosphoramides, carboxylic esters, carboxamides, and alkyl nitrites and aryl nitrites.

15. The process according to claim 10 for preparing highly reactive isobutene homo- or copolymers having a content of terminal vinylidene double bonds of at least 80 mol %.

16. The process according to claim 10 for preparing highly reactive isobutene homo- or copolymers having a polydispersity of at most 2.0.

17. The process according to claim 10 for preparing highly reactive isobutene homo- or copolymers by polymerizing isobutene from a technical C₄ hydrocarbon stream having a content of isobutene of from 30 to 70% by weight, of 1-butene of from 1 to 50% by weight, of cis- and trans-2-butene of from 1 to 50% by weight, of butanes of from 2 to 40% by weight, and up to 1000 ppm by weight of butadiene.

18. The process according to claim 17 for preparing highly reactive isobutene homo- or copolymers by polymerizing isobutene from raffinate 1 or raffinate 1P as the technical C₄ hydrocarbon stream.
